(19) United States
(12) Patent Application Publication
(10) Pub. No.: US 2013/0054275 A1
(43) Pub. Date: Feb. 28, 2013

(54) METHOD FOR VALUING OUTPUT FOR STRUCTURING TRANSACTIONS

(71) Applicant: William B. Goode, Hurricane, WV (US)

(72) Inventor: William B. Goode, Hurricane, WV (US)

(21) Appl. No.: 13/591,713

(22) Filed: Aug. 22, 2012

Related U.S. Application Data
(60) Provisional application No. 61/526,290, filed on Aug. 23, 2011.
(60) Provisional application No. 61/584,327, filed on Jan. 9, 2012.

(51) Int. Cl. G06Q 40/08; G06Q 40/06; G06Q 40/04

(52) U.S. Cl. 705/4

(57) ABSTRACT

A computerized method for monetizing a commodity, product or service in exchange for an insurance product, and valuing assets of an entity in exchange for collateral for surety is disclosed. A request is received by an insurer from an entity for an insurance product. The insurer uses a computer to calculate a cash premium required by the insurer for the insurance product, to calculate an economic output needed to fulfill the cash premium, to calculate a cash premium threshold, and an economic output threshold. The computer instructs via a display, a printout, or a transmission, if the cash premium is greater than the cash premium threshold and if the economic output is greater than the economic output threshold. A computer-readable medium records the terms and data of an agreement for a delivery of economic output by the entity in exchange for an insurance policy provided by the insurer. A delivery of the economic output from the entity to a buyer and a cash premium payment from the buyer to the insurer are also recorded on the computer-readable medium.

### CROSS REFERENCE TO RELATED APPLICATIONS

The present application hereby claims priority under 35 U.S.C. § 119(e) to Provisional U.S. Application No. 61/526,290 filed Aug. 23, 2011, entitled “Innovative Surety Bond,” and claims priority under 35 U.S.C. §119(e) to Provisional U.S. Application No. 61/584,327 filed Jan. 9, 2012, entitled “Innovative Method for Monetizing Insurance.”

### BACKGROUND

The present application generally relates to valuing economic outputs and other assets for structuring transactions among business entities and more particularly to monetizing a commodity, product or service in exchange for an insurance product, and monetizing other assets for collateral for an insurance product.

Insurance is a form of risk management primarily used to hedge against risk of a contingent, uncertain loss. Insurance contracts transfer the risk of a loss from an entity to the insurer, in exchange for payment. The entity may be an individual, a partnership, a government entity, or a corporation. If the insurance contract is a surety, the entity indemnifies the insurer, thus retaining the risk of loss. Other names used for insurance contracts are policy or indemnity agreements. The price for an insurance contract is called the premium. The insurance products or contracts come in many different arrangements, including, but not limited to, policies for types or lines of risk management such as property insurance, casualty insurance, health insurance, life insurance, worker's compensation insurance, etc., or other specialty types or lines such as surety, indemnity agreements, etc.

The underwriting process of an insurer comprises evaluating the risks of insuring an entity, determining whether to accept the risk, and determining a premium price for the insurance contract. The premium is determined by insurance underwriting processes based in part on actuarial and historical data aggregated from many sources.

The premium is paid to the insurer by the entity. Payment is typically made using bank draft, check, or a funds transfer. Payment of premiums may be payable at various times during the effective dates of the insurance product, comprising of annually, semiannually, monthly, or in advance of an insurance contract's effective date. In the normal course of economic activity, for an entity to have available cash to make the premium payments, the entity sells its commodity, product, or service to customers in exchange for cash. The cash proceeds of the sales cover the cost of producing the commodity, product or service, resulting in a remainder of cash, called the gross profit margin. From this gross profit margin the entity pays other expenses including premiums to insurers for insurance products. Additionally, if the insurance is surety, collateral from and indemnification by the entity is typically required by the insurer. Collateral is typically provided in the form of letters of credit issued by financial institutions, i.e. banks. Financial institutions require collateral from the entity to support the issuance of their letters of credit. The collateral may be in the form of liens or rights to an entity's assets. This is undesirable because it requires additional steps of converting the commodity, product or service to cash before being able to purchase the insurance product.

For example, there are situations where the entity does not have enough cash to pay for the premium. In these situations, the entity may have to do without the insurance product. This is disadvantageous for the entity for a variety of risk management and operational reasons. One major disadvantage would be if the entity were required by a government entity to have the insurance product in place before the entity could conduct their business. In situations where the entity does not have enough cash, the entity must take out loans or leverage their collateral to raise enough cash to pay for the premium.

Accordingly, there is a need for an improved method, specifically a computerized method, for improving financial and insurance transactions, especially for cash poor entities.

### SUMMARY

The disclosure describes a computerized method for monetizing a commodity, product or service in exchange for an insurance product, and valuing assets of an entity in exchange for collateral for surety. A request is received by an insurer from an entity for an insurance product. The insurer uses a computer to calculate a cash premium required by the insurer for the insurance product, to calculate an entity's economic output needed to fulfill the cash premium, to calculate a cash premium threshold, and an economic output threshold. The computer instructs via a display, a printout, or a transmission, if the cash premium is greater than the cash premium threshold and if the economic output is greater than the economic output threshold. A computer-readable medium records the terms and data of an agreement for a delivery of economic output by the entity in exchange for an insurance policy provided by the insurer. A delivery of the economic output from the entity to a buyer and a cash premium payment from the buyer to the insurer are also recorded on the computer-readable medium.

Another embodiment of the disclosure describes a computerized method for conducting a collateral exchange transaction. The computer is used to calculate an available bonding capacity of an entity by subtracting an entity's total outstanding surety bonds from an entity's total bonding capacity to determine the available bonding capacity via a processor, wherein the total outstanding surety bonds and total bonding capacity are retrieved from a database. The computer will indicate approval on a display unit if the available bonding capacity is equal to or greater than a new bond amount. The computer will then calculate an available collateral balance of an economic output by subtracting a current value of collateral from the product of outstanding surety bonds and a collateral coverage rate via the processor wherein the collateral coverage rate and the current value of collateral are retrieved from the database and the collateral coverage rate is the quotient of the value of collateral and the outstanding surety bonds. The computer will instruct via the display unit the issuance of a new bond if the new bond amount multiplied by the collateral coverage rate is equal to or greater than the available collateral balance and record to a computer-readable medium delivery of a economic output to a buyer from the entity via the processor, the economic output being calculated using the processor by retrieving from the database a collateral premium rate and a collateral price and dividing the collateral premium rate by the collateral price. The computer will record to a computer-readable medium a cash premium for the economic output paid from the buyer to an insurer wherein the cash premium is calculated using the processor by retrieving from the database the new bond amount and a currency premium rate and multiplying the new bond amount by the currency premium rate to determine the cash premium.

It is desirable to have a computer collect information from sources to include the internet and run algorithms designed for valuing output and assets and structuring transactions based on exchanging a commodity, product, or service produced by an entity in exchange for the insurance product as an alternative to cash transactions and collateral, such as letters of credit.

### BRIEF DESCRIPTION OF THE DRAWINGS

The present disclosure will become more fully understood from the following detailed description, taken in conjunction with the accompanying figures, wherein like reference numerals refer to like elements, in which:

FIG. 1 is a flowchart showing a computerized method for monetizing a commodity, product or service for an insurance product; and

FIG. 2 depicts a computerized method for conducting the exchange of the insurance product for economic output.

### DETAILED DESCRIPTION

It should be understood that the application is not limited to the details or methodology set forth in the description or illustrated in the figures. It should also be understood that the terminology is for the purpose of description only and should not be regarded as limiting.

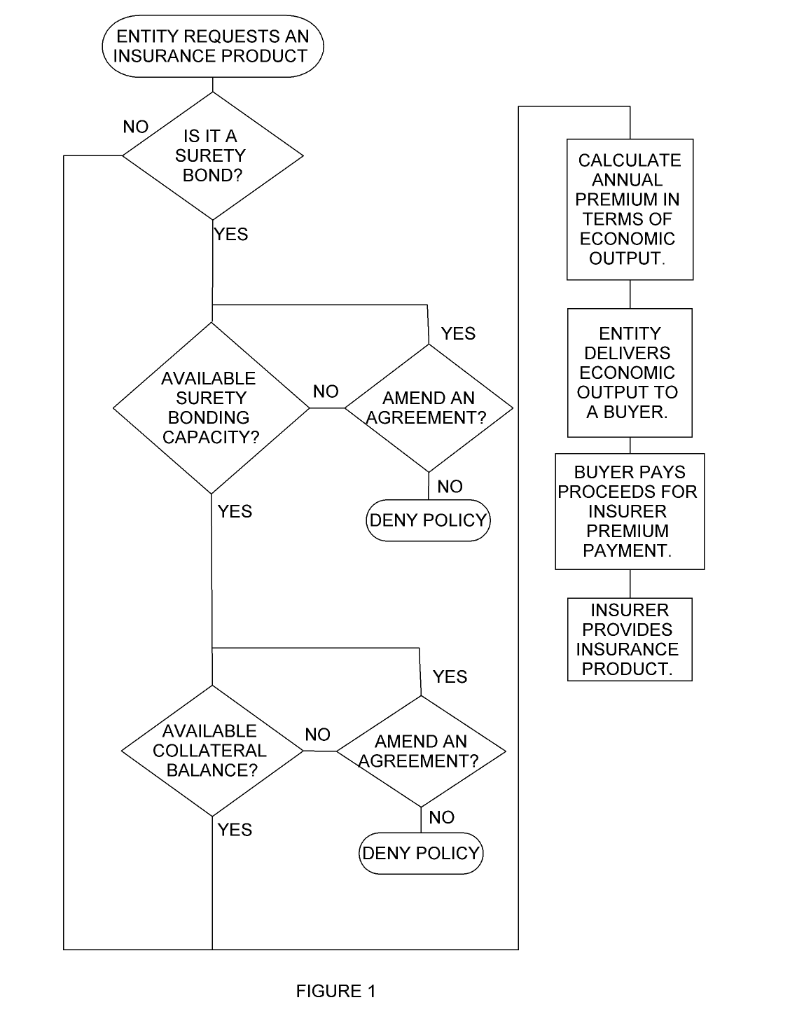

Referring to FIG. 1, the entity has the need for an insurance product and communicates that need to an insurer by making a request for the insurance product. The entity may be an individual, a partnership, a government entity, or a corporation. The insurance product is an insurance contract, a policy, or a surety where the provisions and wording of the insurance product are regulated by insurance commission or surety obligees. The insurance product includes but is not limited to: property insurance, casualty insurance, surety, health insurance, life insurance, worker's compensation insurance, etc. Qualification for the insurance product is determined by a computer running an algorithm. The need for the insurance product may be because the entity wants to manage risk and protect from a loss due to fire, theft, or any other event to which the entity will lose a commodity, product, the ability to provide the service, or the revenue from those products or services. The insurer is an insurance company, or a syndicate of companies or individuals, that provides the insurance product.

The insurer may need to evaluate the entity to determine if the entity can compensate the insurer for the insurance product by using a processor of the computer. The insurer will use the computer to run the calculation. The computer will access the internet, the database, commodities or stock exchange, published indices, a data center, or any other repository of information that is accessible by computer to retrieve an entity data. The entity data is any information relevant to the calculations performed by the computer. Entity data may include commodity price information, entity stock information or any other data relevant to the entity or provided by the entity. The computer will access the entity data, store the entity data to a computer-readable medium, and use the entity data in its calculations explained below

The insurer will execute an underwriting, marketing, and rating process to determine a premium required by the insurer for this insurance product on the computer. The premium is a cash value or price as determined by the processor of the computer. The processor will seek an information on the entity's: operations; financial position; total face amount of surety bonds the entity current possess; any other requests for surety bonds from other insurers; an amount of collateral the entity has; and what the entity's commodity, product, or service. The entity can enter this information online, at a terminal or it may be given to the insurer to be entered and the information may be part of an entity's data used for the computer calculations. The information received by the insurer is used to aid the processor in sizing the scope of coverage of the insurance product. The processor will evaluate the entity's information and determine a risk assessment associated with insuring the entity. The processor will also assess a requested set of terms by the entity for the insurance product and adjust the risk assessment based of the requested set of terms. Based upon the risk assessment, and other underwriting and market factors, the processor will determine the premium required by the insurer from the entity for the insurance product. The processor will then equate the premium in terms of either the cash transaction or an economic output of the entity. The calculation of the value of the economic output is a process performed by the processor to equate a monetary value of the premium to the commodity, product, or service to the premium of the insurance product provided by the entity. Economic output may be the commodity, product, or service produced by the entity. Economic output may also be a collateral of the entity. The collateral are assets pledged by the entity to secure a loan, line of credit, insurance product to include a surety, or any other product or service the entity desires. For example, inventory may be collateral and may be the economic output of the entity, but not yet sold. Other examples of collateral as economic output may be mineral rights, mineral reserves, the rights to government permits, coal reserves, or any other item, tangible or intangible, that holds value for the entity's advantage. A buyer, for example a commodity trading company, would value these assets, as inputs into the economic output, and accept them as collateral.

Once the insurer determines, through its normal underwriting, marketing, and rate determination processes and the premium required by the insurer for this insurance product and as calculated by the computer, the insurer and the entity will agree to an insurance policy or policies. Separately, the insurer and entity will enter into an agreement to govern the rights and responsibilities of the insurer and the entity in regards to exchanging the entity's economic output for insurance products from the insurer. The agreement may be between at least two or more parties that sets forth a set of terms for a transaction for the exchange of the insurance product for a cash premium. An insurance policy is a contract that includes provisions comprising of declarations, definitions, insuring agreements, conditions, and exclusions, limits of liability, contract performance, and indemnification. The terms of the agreement generally include and are not limited to: quantity, quality, and valuation of the economic output; place, time, and method of delivery of the economic output; delivery instructions; insurance product coverage; limits of liability; surety bond face value; valuation or process for valuation of the economic output; processes for determining valuation of the economic output at future dates; how changes in the premium are calculated; etc. A non-exhaustive list of buyer's terms in the agreement may include: terms for transactions, effective dates, termination dates and methods, delivery methods, delivery locations, specifications, weighing, sampling, analysis, quality adjustments, rejections, settlements, guaranty, force majeure, defaults, and remedies. The terms of the agreement may include any other commercially recognized terms.

Certain terms and data of the agreement will be recorded to a computer-readable medium or a memory device for later retrieval and use by the computer or insurer. A hard copy of a legally binding instrument based on the agreement will be made via a printout and signed by both the insurer and the entity. Alternatively, the agreement between parties may be completed electronically via electronic signatures or digital certificates.

When a premium for the insurance product is due to be paid, the entity will provide its commodities, products, or services, as required by the agreement, for the benefit of the insurer. A potential third party to the agreement is the buyer. The relationship between the entity, the insurer, and the buyer may be formed at any time during the duration of the agreement. The buyer may be one buyer or multiple buyers and a buyer or multiple buyers may be added at a date later then an agreement date. The agreement may be between the entity and the insurer only, or it may include the buyer or multiple buyers. The buyer's terms are incorporated into the agreement and may comprise: a price per quantity of economic output, processes for determining valuation at future dates, delivery dates, and delivery instructions. , termination dates and methods, delivery methods, delivery locations, specifications, weighing, sampling, analysis, quality adjustments, rejections, settlements, guaranty, force majeure, defaults, and remedies. The insurer may also be the buyer or the insurer may be affiliated with the buyer.

The buyer is a company or individual who purchases the entity's economic output of commodities, products, or services. Based on the terms of the agreement, the processor calculates the economic output, and other terms related to the delivery of the economic output, required by the insurer to provide the insurance product. The entity will provide the economic output, per the agreement, for the benefit of the insurer. If the economic output is provided to the buyer, the buyer will in turn remit a cash payment to the insurer as payment of the premium of the entity's insurance product.

The buyer may or may not be a party to the insurance contract or agreement. The buyer may enter into a separate buying agreement with the entity and the insurer. The buying agreement may govern for example: how the economic output is delivered, how rejection of the economic output is handled, how the buyer will pay the insurer for the economic output, accountability.

The terms discussed may be programmed into the computer and are selectable by the insurer, entity, or buyer. Once the terms are selected and data from the agreement are entered into the computer, the processor may calculate the economic output of the entity needed to satisfy a buyer's payment of the cash premium of an insurance product for the entity. The economic output is calculated by multiplying a quantity and a valuation of the commodity, product, or service provided by the entity. Conversely, the cash premium may be used to calculate a quantity of economic output. The computer will also calculate a cash premium threshold and an economic output threshold. Using the entity data, the computer will determine the threshold amount of cash premium and economic output needed from the entity to meet the requirements of the insurer. Those cash premium threshold and the economic output threshold may be the minimum amount of cash premium or the minimum amount of economic output required from the entity. The computer will indicate via a display, a printout, or a transmission if the cash premium and the required economic output are determined by the computer to be sufficient for the insurer to issue the insurance product to the entity and satisfy terms for the buyer. The insurer will communicate with the entity and the buyer the calculation of economic output and will communicate with the buyer the cash premium.

The insurer will record a premium payment from the buyer to the insurer to fulfill the cash premium of the entity on either a form or in the computer via the computer readable medium. The insurer can also record the delivery of the economic output from the entity to the buyer either on a form or in the computer via the computer readable medium. The information inputted into the computer, to include the recorded information, will be saved for later retrieval or displayed in real time.

If the computer, through its calculations, determines that the entity fails to meet the requirements for the insurer to sell the insurance product, the entity and the insurer may mutually amend the terms of the insurance product or agreement. Upon new terms being entered into the computer or selected, the computer will calculate a new cash premium. Furthermore, a new economic output needs to be calculated to fulfill the new cash premium. If the delivery of the economic output is a future date, time value factors can be inputted into the computer, retrieved from the database, or the entity data. The future date is a term of the new agreement or a new term of the agreement and will dictate the outcome of the amount of economic output that is needed for the change in the new cash premium. The computer will calculate a new cash premium when the delivery of the economic output is a future date and a new economic output needed to fulfill the new time-valued cash premium. The new cash premium reflects the value of the insurance product at the future date as well as the new economic output needed to at the future date.

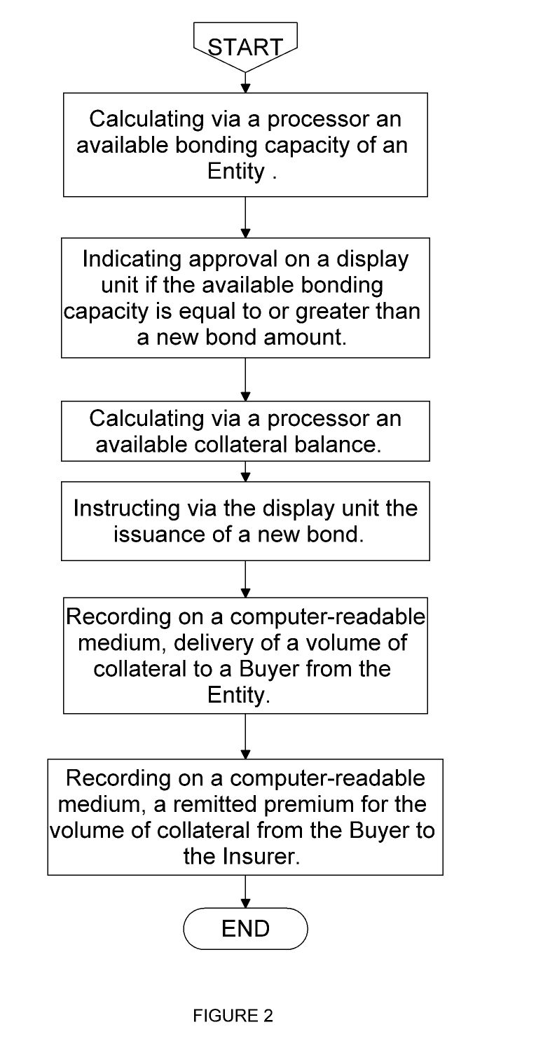

FIG. 2 depicts a computerized method for conducting the exchange of the insurance product for economic output. The entity's insurance product request may be a surety, requesting a single surety bond, multiple surety bonds, and/or a commitment for a total amount of surety bonds desired in the future. Surety is provided in a three-party contract called a surety bond. The three parties are an obligee, the insurer and the entity (typically referred to as “principal”). The obligee will determine the form and face value of each surety bond. The obligee may be a government agency, commercial enterprise, individual, or any other type of party. The insurer determines through it normal underwriting processes whether entity has the financial and operational capability and capacity to satisfy the requirements of the surety bond, and an available bonding capacity for the entity. The total bonding capacity is a maximum limit that the insurer will provide in total face value of surety bonds for the entity. The total bonding capacity means the maximum sum of the face value of all surety bonds that the insurer will issue and could have outstanding at any point in time for the entity. In other words, the available surety bonding capacity plus outstanding surety bonding capacity will equal total surety bonding capacity.

The available bonding capacity is a total bonding capacity of the entity minus the outstanding surety bonds. This is the amount of surety bonds that could be issued in the future. The outstanding surety bond is a total amount of surety bonds the insurer has currently provided and is in force for the entity. If the available bonding capacity is determined by the computer calculations to be not approved, the agreement can mutually be amended. If the available bonding capacity is determined by the computer to be approved, the computer will calculate an available collateral balance of the entity. Available collateral balance means the total value of assets or economic output that have been designated as collateral to support the issuance of surety bonds less the amount of collateral that has been pledged or assigned to currently outstanding surety bonds. Available collateral balance will be pledged to future surety bonds to be issued. The available collateral balance is a total amount of collateral minus a collateral amount assigned to the outstanding surety bonds. If the available collateral balance is determined by the computer to be not approved, the agreement can mutually be amended. If the available collateral balance is determined by the computer to be approved, the entity will deliver the economic output as per the agreement. Furthermore, the buyer will purchase the economic output and remit payment to insurer as described above. The insurer will issue the surety bond to the obligee on behalf of the entity.

The computer will instruct the insurer of an acceptable amount of the available bonding capacity or an acceptable amount of available collateral balance if either of the above calculations is not approved. The acceptable amount of available bonding capacity is the difference from the above calculation for available bonding capacity that was not approved. The acceptable amount of available collateral balance is the difference of the above calculation for available collateral balance that was not approved. The insurer may use these calculations in amending the agreement.

The computer is used to calculate an available bonding capacity of an entity by subtracting an entity's total outstanding surety bonds from an entity's total bonding capacity to determine the available bonding capacity via a processor, wherein the total outstanding surety bonds and total bonding capacity are retrieved from a database. A total outstanding surety bond means the sum of the face value of all surety bonds that the insurer has issued and is currently held by obligees. The computer will indicate on a display unit if the available bonding capacity is equal to or greater than a new bond amount. The display unit may be a computer monitor, a printer, or a transmission to another device.

The computer will continue by calculating an available collateral balance of the economic output by subtracting a current value of collateral from the product of outstanding surety bonds and a collateral coverage rate via the processor. The collateral coverage rate and the current value of collateral are retrieved from the database and the collateral coverage rate is the quotient of the value of collateral and the outstanding surety bonds. The value of collateral is the total collateral capacity of the entity. In other words, the collateral coverage rate means the percentage of the value of collateral in portion to the face amount of the surety bonds or total collateral capacity divided by total bonding capacity. The collateral coverage rate would probably be agreed to upfront, and then as each bond is issued, the collateral coverage rate would determine how much of the collateral would be pledged to that bond. The computer will then indicate using the display unit whether the issuance of a new bond if the new bond amount multiplied by the collateral coverage rate is equal to or greater than the available collateral balance is approved. The economic output or other assets, such as the inputs necessary for the entity to produce the outputs, may be the collateral of the entity.

The computer will record the delivery of an economic output to a buyer from the entity, the economic output being calculated using the processor by retrieving from the database a collateral premium rate and a collateral price and dividing the collateral premium rate by the collateral price and the computer will record a cash premium for the economic output from the buyer to an insurer wherein the cash premium is calculated using the processor by retrieving from the database the new bond amount and a currency premium rate and multiplying the new bond amount by the currency premium rate to determine the cash premium.

A situation may arise where the delivery of the collateral does not happen immediately but will happen at a future date. The numbers used to calculate the cash premium and the economic output will not be accurate to reflect the future value of the cash premium or economic output using the contemporary values. Therefore, the computer calculations need to be redone to account for a future delivery date. The computer may recalculate a change in the cash premium when the delivery of the economic output is a future date wherein an interest rate and a number of future days are retrieved from the database and a future value premium is calculated using the processor by multiplying the premium by the number of future days divided by 365 and multiplying that product by the sum of one plus the interest rate and the processor displays the future premium value on a display. Furthermore, the computer will recalculate a change in the economic output when the delivery of the economic output is the future date wherein a future price of collateral is retrieved from the database and a future economic output is calculated using the processor by dividing the future value premium by the future price of collateral and the processor displays the future economic output on the display.

Once the new cash premium and economic value of the collateral is established an agreement is signed between the entity and the insurer, the insurer and the buyer, and the buyer and the entity setting terms for monetizing the collateral. After the agreement is signed, the insurer issues a bond to the entity if the insurance product is a surety. The agreement may also call for the insurer to issue the bond to a third party such as a government entity. The third party would in turn issue a permit or license to the entity. The agreement may be signed by the entity and the insurer, the insurer and the buyer, and the buyer and the entity setting terms for monetizing the collateral.

Examples of commodities, products, and services include, but are not limited to: metals such as gold, silver, or copper, etc.; agricultural products such as corn, wheat, soybeans, cattle, lumber, mile, coffee, sugar, orange juice, cotton, etc.; energy such as gasoline, natural gas, coal, electricity, etc.; products such as chemicals, tobacco, textiles, apparel, wood, paper, pharmaceuticals, plastics, nonmetallic minerals, manufactured metals, machinery, computers, electrical equipment and supplies, transportation, etc.; and services such as transportation, warehousing, finance, professional, scientific, technical, health care, arts, entertainment, etc.

While the present disclosure has been particularly shown and described with reference to specific embodiments, it should be understood by those skilled in the art that various changes in form and detail may be made therein without departing from the spirit and scope of the disclosure as defined by the appended claims. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example Likewise, although claimed subject matter is not limited in scope in this respect, one embodiment may comprise one or more articles, such as a storage medium or storage media. This storage media, such as, one or more CD-ROMs and/or disks, for example, may have stored thereon instructions, that if executed by a system, such as a computer system, computing platform, or other system, for example, may result in an embodiment of a method in accordance with claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive.

Likewise, the terms, “and,” “or,” and “and/or” as used herein may include a variety of meanings that will depend at least in part upon the context in which it is used. Typically, “and/or” if used to associate a list, such as A, B and/or C, is intended to mean A, B, or C as well as A, B and C. Similarly, “or” if used to associate a list, such as A, B or C, is intended to mean A, B, or C as well as A, B and C. Though, it should be noted that this is merely an illustrative example and claimed subject matter is not limited to this example.

The present disclosure may be embodied in hardware and/or in software (including firmware, resident software, micro-code, etc.). Furthermore, the present disclosure may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present disclosure may be written in a high-level programming language, such as C or C++, for development convenience. In addition, computer program code for carrying out operations of the present disclosure may also be written in other programming languages, such as, but not limited to, interpreted languages. Some modules or routines may be written in assembly language or even micro-code to enhance performance and/or memory usage. However, software embodiments of the present disclosure do not depend on implementation with a particular programming language. It will be further appreciated that the functionality of any or all of the program modules may also be implemented using discrete hardware components, one or more application specific integrated circuits (ASICs), or a programmed digital signal processor or microcontroller.

The present disclosure is described below with reference to block diagram and flowchart illustrations of methods, apparatus (systems) and computer program products according to embodiments of the disclosure. It will be understood that each block of the block diagrams and/or flowchart illustrations, and combinations of blocks, can be implemented by computer program instructions and/or hardware operations. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the block diagram and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function specified in the block diagram and/or flowchart block or blocks.

The computer program instructions may also be loaded onto a computer or other programmable data processing apparatus to cause a series of operational steps to be performed on the computer or other programmable apparatus to produce a computer implemented process or method such that the instructions which execute on the computer or other programmable apparatus provide steps for implementing the functions specified in the block diagram and/or flowchart block or blocks.

It should be noted that, in some alternative embodiments, the functions noted in the blocks may occur out of the order noted in the figures. For example, two blocks shown in succession may in fact be executed substantially concurrently or the blocks may sometimes be executed in the reverse order, depending on the functionality involved. Furthermore, in certain embodiments of the present disclosure, such as object oriented programming embodiments, the sequential nature of the flowcharts may be replaced with an object model such that operations and/or functions may be performed in parallel or sequentially.

What is claimed is:

1. A computerized method for calculating economic output as a medium of exchange, the method comprising:
receiving a request from an entity for an insurance product;
calculating via a processor a cash premium required by an insurer for the insurance product;
calculating via the processor an economic output needed to fulfill the cash premium;
calculating via the processor a cash premium threshold and an economic output threshold;
instructing via a display, a printout, or a transmission, if the cash premium is greater than the cash premium threshold and if the economic output is greater than the economic output threshold;
recording to a computer-readable medium terms and data of an agreement for a delivery of economic output by the entity in exchange for an insurance policy provided by the insurer;
recording to a computer-readable medium a delivery of the economic output from the entity to a buyer; and
recording to the computer-readable medium the cash premium the buyer pays to the insurer.

2. The method of claim 1, further comprising:
calculating via the processor a new cash premium when the delivery of the economic output is a future date; and
calculating via the processor a new economic output needed to fulfill the new time-valued cash premium.

3. The method of claim 1, further comprising producing a hard copy via the printout of a legally binding instrument to be signed by the entity and the insurer.

4. The method of claim 1, wherein the insurance product is a surety bond.

5. The method of claim 1, further comprising:
calculating and recording an available bonding capacity of the entity, under terms of the agreement to value economic assets of the entity;
instructing via the display, the printout, or the transmission if the available bonding capacity is determined to be approved;
calculating an available collateral balance of the entity; and
instructing via the display, the printout, or the transmission if the available collateral balance is determined to be approved.

6. The method of claim 5, further comprising:
instructing via the display, the printout, or the transmission an acceptable amount of available bonding capacity if the available bonding capacity is determined to be declined; and
instructing via the display, the printout, or the transmission an acceptable amount of available collateral balance if the available collateral balance is determined to be declined.

7. The method of claim 1 wherein the insurer is the buyer.

8. A computerized method for conducting a collateral exchange transaction, the method comprising:
calculating an available bonding capacity of an entity by subtracting an entity's total outstanding surety bonds from a entity's total bonding capacity to determine the available bonding capacity via a processor, wherein the total outstanding surety bonds and total bonding capacity are retrieved from a database;
indicating approval on a display unit if the available bonding capacity is equal to or greater than a new bond amount;
calculating an available collateral balance of an economic output by subtracting a current value of collateral from the product of outstanding surety bonds and a collateral coverage rate via the processor wherein the collateral coverage rate and the current value of collateral are retrieved from the database and the collateral coverage rate is the quotient of the value of collateral and the outstanding surety bonds;
instructing via the display unit the issuance of a new bond if the new bond amount multiplied by the collateral coverage rate is equal to or greater than the available collateral balance;
recording to a computer-readable medium delivery of a economic output to a buyer from the entity via the processor, the economic output being calculated using the processor by retrieving from the database a collateral premium rate and a collateral price and dividing the collateral premium rate by the collateral price; and
recording to a computer-readable medium a cash premium for the economic output paid from the buyer to an insurer wherein the cash premium is calculated using the processor by retrieving from the database the new bond amount and a currency premium rate and multiplying the new bond amount by the currency premium rate to determine the cash premium.

9. The method of claim 8, further comprising recalculating a change in the cash premium when the delivery of the economic output is a future date wherein an interest rate, a number of future days are retrieved from the database and a future value cash premium is calculated using the processor by multiplying the cash premium by the number of future days divided by 365 and multiplying that product by the sum of one plus the interest rate and the processor displays the future premium value on a display.

10. The method of claim 9, further comprising recalculating a change in the economic output when the delivery of the economic output is the future date wherein a future price of collateral is retrieved from the database and a future economic output is calculated using the processor by dividing the future value premium by the future price of collateral and the processor displays the future economic output on the display.

11. The method of claim 10, wherein an agreement is signed between the entity and the insurer, the insurer and the buyer, and the buyer and the entity setting terms for monetizing the economic output.

12. The method of claim 11, wherein the insurer issues a bond to the entity.

13. The method of claim 11, wherein the insurer issues a bond to a third party.

14. The method of claim 13, further comprising issuing a permit or license from the third party to the entity.

15. The method of claim 8, wherein the insurer issues a bond to the entity.

16. The method of claim 8, wherein the insurer issues a bond to a third party.

17. The method of claim 16, further comprising issuing the permit or license from the third party to the entity.

18. The method of claim 8, wherein an agreement is signed between the entity and the insurer, the insurer and the buyer, and the buyer and the entity setting terms for monetizing the economic output.
